(19) United States
(12) Patent Application Publication
(10) Pub. No.: US 2023/0383599 A1
(43) Pub. Date: Nov. 30, 2023

(54) SHADE CONFIGURED TO BE CHANGED IN WIDTH AND HEIGHT AND CONFIGURED TO TRANSFORM BETWEEN DIFFERENT TYPES OF SHADES

(71) Applicant: Wondershades LLC, New York, NY (US)

(72) Inventor: Jason B. Teuscher, New York, NY (US)

(21) Appl. No.: 18/203,355

(22) Filed: May 30, 2023

Related U.S. Application Data
(60) Provisional application No. 63/346,439, filed on May 27, 2022.

(51) Int. Cl. E06B 9/42

(52) U.S. Cl. CPC E06B 9/42; E06B 2009/402

(57) ABSTRACT

A shade is provided that can be modified and customized in terms of width and height, while also being transformed from a first type of shade to a second type of shade. In an embodiment, The shade may include a shade pull portion coupled to at least one or more shade coverings that cover a window covering. The shade pull portion may retract and lowering to raise and lower the shade. The shade may also include one or more fold portions that are configured to be modified to change the shade to one or more different widths. Even more, each of the one or more shade coverings may be coupled at different heights of the shade to modify the shade in height and/or transform the shade from a first type of shade (e.g., flat front shade) to a second type of shade (e.g., hobbled shade).

### CROSS-REFERENCE TO RELATED APPLICATIONS

The present application claims the benefit of U.S. Provisional Patent Application Ser. No. 63/346,439, which was filed on May 27, 2022, by Jason B. Teuscher for SHADE CONFIGURED TO BE CHANGED IN WIDTH AND HEIGHT AND CONFIGURED TO TRANSFORM BETWEEN DIFFERENT TYPES OF SHADES, which is hereby incorporated by reference.

### BACKGROUND

### Field of the Invention

The present invention relates to a window shade that can be configured to transform between types of window shades and can be in adjusted in terms of width and height.

### Description of the Related Art

Window shades are mostly tailored in terms of size and shape for individual windows. Typically, manufacturers of window shades create shades, to be sold at retailers, for window that are considered standard in terms of size and shape. Therefore, a consumer will have to have a window with the standard shape.

Furthermore and importantly, once the fabric for the window shade is cut and sewn by, for example, a manufacturer, the window shade cannot typically be further modified. Moreover, exact measurements are required which can frustrate consumers since measuring windows is time consuming and precise measurements are required for fabric cutting and sewing, which adds additional costs and time. Using a single piece of fabric to transform a window treatment allows the consumer to not only create many tailored looks but also create an exact fit. This saves time and money and relieves the consumer of concerning measurements and frees the consumer to transform one shade into another without the hassle of a new purchase. Manufacturing is simplified since the time and cost devoted to tailored processes are now able to manufacture in scale while still providing design and size flexibility. Additionally, classifications of window treatments have been hard wired into consumers since mix and matching designs are not available, by using a cloth with various attaching mechanisms new treatments can now be created.

### BRIEF DESCRIPTION OF THE DRAWINGS

The description below refers to the accompanying drawings, of which:

FIGS. 1A and 1B are respectively a front and a back view of an illustrative window shade with cloth that can be modified in terms of height and/or width and may also transform from a first type of shade to a second type of shade according to the one or more embodiments described herein;

FIG. 1C depicts a shade modified in height utilizing back transforming members mating according to the one or more embodiments as described herein;

FIG. 1D depicts a close-up of front transforming members that can mate to modify a height and/or type of a shade according to the one or more embodiments as described herein;

FIG. 1E depicts a close-up of front transforming members that are mated such that the shade is modified in height and/or type according to the one or more embodiments as described herein;

FIG. 1F is a close-up view of a raising clip with opening that is engaged with ribbon according to the one or more embodiments as described herein;

FIGS. 2A and 2B illustrate a different shade may be transformed to a hobbled or teardrop Roman shade according to the one or more embodiments as described herein;

FIGS. 3A and 3B illustrate an alternative SHADE that may be transformed width and/or height according to the one or more embodiments as described herein;

FIG. 4 is an illustration of a shade that may be utilized as an awning according to the one or more embodiments as described herein; and

FIGS. 5A and 5B illustrate a shade that may utilize strengthening rods that may be utilized to change a height of a shade and/or a type of shade according to the one or more embodiments as described herein;

FIG. 6 depicts a shade with a shade pull retracting/releasing portion and strengthening rods that may according to the one or more embodiments as described herein;

FIG. 7 depicts a shade that is similar to FIG. 6 but without strengthening rods according to the one or more embodiments as described herein;

FIG. 8 depicts a shade that is similar to FIG. 7 but with clips that are coupled to each other using a securing mechanism that, as depicted, is a loop according to the one or more embodiments as described herein;

FIG. 9 depicts a shade with shade pull retracting/releasing portion, ribbons, and strengthening rods according to the one or more embodiments as described herein;

FIG. 10 depicts a top-down shade that is similar to the shade of FIG. 9 according to the one or more embodiments as described herein; and

FIG. 11 is a top-down shade similar to the shade of FIG. 10, however, the shade of FIG. 11 includes a plurality of strengthening rods at each level according to the one or more embodiments as described herein.

### DETAILED DESCRIPTION OF AN ILLUSTRATIVE EMBODIMENT

It is the primary objective of the present invention to provide a shade that can be modified/adjusted (length and width) and can also be transformed between different types of window shades. For example, and according to the one or more embodiments described here, the window treatment may be transformed from a Flat Roman Shade to a Hobbled Roman Shade, to a mixture of a Flat Roman Shade and Hobbled Roman shade, or a curtain, etc. In addition to be utilized to cover a window, the window shade according to the one or more embodiments described herein may also be utilized as a shower curtain or a protective cover to, for example, cover furniture of different shapes and dimensions.

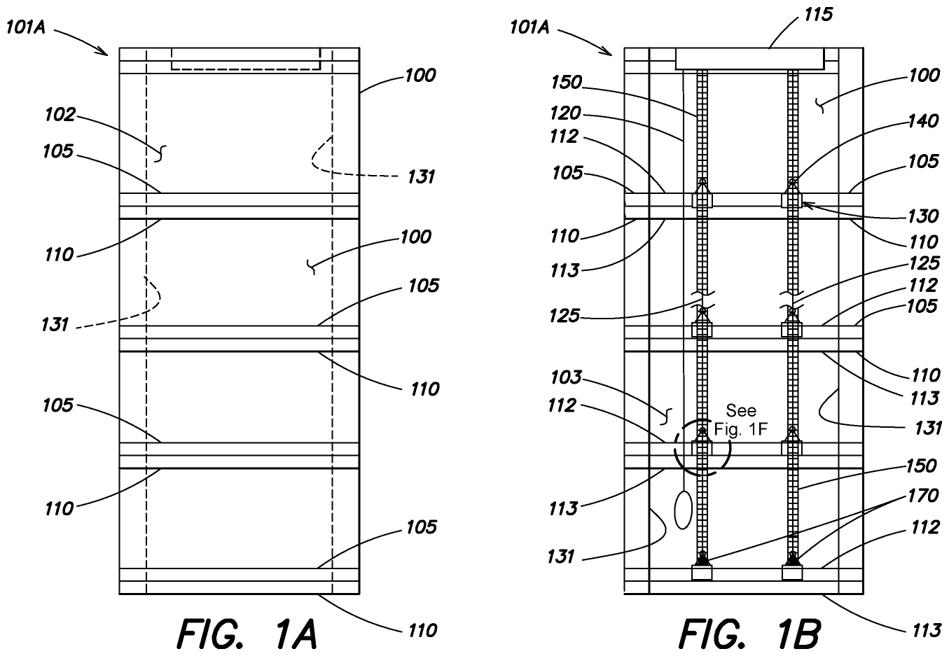

FIGS. 1A and 1B are respectively a front and a back view of an illustrative window shade with cloth that can be modified in terms of height and/or width and may also transform from a first type of shade to a second type of shade according to the one or more embodiments described herein. Shade 101A includes cloth 101 is for illustrative purposes only, and it is expressly contemplated that shade 101A according to the one or more embodiments as described herein may include any material that can be used to cover a window opening, for example. Such materials may include, but are not limited to, fabric, plastic, bamboo, paper, etc. The window shade 101A of FIGS. 1A and 1B is in a configuration of a flat front Roman shade. Specifically, cloth 100 of window shade 101A does not, for example, include one or more folds and is instead flat. In an embodiment, cloth 100 is a single piece of cloth. Alternatively, cloth 100 may be multiple pieces of cloth that are coupled together. Cloth 100 may include a front side 102 and a back side 103. In an implementation, front side 102 may be the front side of the window shade 101A that is facing and visible to one or more individuals that may be on an interior side of the window of a window opening (not shown). In an implementation, back side 103 of window shade 101A may be the side of the window shade 101A that is facing the interior of the window that is not visible to the one or more individuals. Window shade 101A may, in an embodiment, include a headrail 115 (visible in FIG. 1B but not visible in FIG. 1A) that is coupled to the cloth 100 such that a top of the cloth 100 may be secured to a top portion of a window opening by way of the headrail 115. In an embodiment, the window shade 101A may be secured to a window opening without the head rail 115 and instead may utilize any of a variety of different securing mechanisms that secure the cloth 100 directly to the frame of the window opening, for example.

As depicted in FIGS. 1A and 1B, a plurality of front transforming members 105 and 110 may be coupled to cloth 100 at one or more different positions along the cloth 100. Each of transforming members 105 and 110 may be any of a variety of different materials. For example, each of transforming members 105 and 110 may be cloth, plastic, wood, etc. As depicted in FIG. 1A, each of the front transforming members 105 have a bottom surface that is in contact with the cloth 100 and a top surface that is not contact with the cloth 100. Stated another away, the bottom surface of the transforming members 105 and 110 may be coupled to front side 102 of cloth 110, while the top surface of the transforming members 105 and 100 are not attached to front side 102 of cloth 100 as depicted in FIG. 1A.

Although FIG. 1A depicts front side 102 of cloth 110 include front transforming members 105 and 110, it is expressly contemplated that the shade 101A according to the one or more embodiments as described herein may include no front transforming members 105 and 110. Further, although reference is made to front side 102 of window shade 101A including both front transforming members 105 and 110 that are adjacent to each other at a particular location, it is expressly contemplate that only one of front transforming members 105 and 110 may be included with window shade 101A.

As will be described in further detail below, the front transforming members 105 and 110 may be utilized to transform/modify the height of the shade 101A. In addition or alternatively, and as will be described in further detail below, the front transforming members 105 and 110 may be utilized to transform shade 101A from a first type (e.g., flat front) of shade to a second type (e.g., pleated front with folds) of shade.

In an embodiment, and as described with reference to FIGS. 1A and 1B, the front transforming members 105 and 110 may be strips having a width that is less than, equal to, or greater than the width (e.g., horizontally) of the cloth 100 of window shade 101A. Alternatively, and instead of being strips, the front transforming members 105 and 110 may be different units (not shown) that are positioned at one or more horizontal positions across or on cloth 100 of window shade 101A. Although FIG. 1A illustrates front transforming members 105 and 110 traveling in a manner that is level horizontally across front side 102 of cloth 100 of shade 101A, it is expressly contemplated that the front transforming members 105 and 110 may travel diagonally or in any direction across front side 102 of cloth 100. Further, front transforming members 105 and 110 may be any shape, size, etc.

Each of front transforming members 105 and 110 may have a bottom surface that is attached to the cloth 100 as depicted in FIG. 1A, where the bottom surface of the front transforming members 105 and 110 may include a first portion of a securing mechanism. Front side 102 of cloth 100 may include one or more second portion of the same securing mechanism that can mate with the first portions of the securing mechanism on the bottom surfaces of the front transforming members 105 and 110. As such, and when the bottom surfaces of the front transforming members 105 and 110 contact the front side 102 of cloth 100, the front transforming members 105 and 110 may attach to the cloth 100 of window shade 101A through the mating. In an implementation, the securing mechanism between the transforming members 105/110 and the front 102 of cloth 100 may be any of a variety of different types of securing mechanisms.

Specifically, the type of securing mechanism may include, but is not limited to, hooks and loops, magnets, buttons, zippers, snaps, clips, belt loops, glue, etc. For example, the bottom surface of the front transforming members 105/110 may be include a plurality of hooks and the front side 102 of cloth 100 may include a plurality of loops that mate to form a hook and loop type securing mechanism. As such, contact/engagement between plurality of hooks on the bottom surface of the front transforming members 105/110 and plurality of loops on the front side 102 of cloth 100 causes the front transforming members 105/110 to attach to the window shade 101A.

The top surface of front transforming members 105 and 110 may respectively include different portions of a securing a mechanism (e.g., hooks and loops, magnets, button, zippers, snaps, belt loops etc.) such that the front transforming member 105 and 110 that are adjacent, for example, can be coupled to each other to modify/transform a height of the shade 101A and/or transform the shade from a first type to a second type.

FIG. 1B depicts back side 103 of cloth 100 of window shade 101A that is a flat front Roman shade. Back side 103 of window shade 101A may include back transforming members 112 and 113. As depicted in FIG. 1B, back transforming members 112 and 113 may include bottom surfaces that are in contact with back side 103 of cloth 100 and a top surface that is not in contact with back side 103 cloth 100. The back transforming members 112 and 113 may be located at one or more different positions on back side 103 of cloth 100. As will be described in detail below, the back transforming members 112 and 113 may be utilized to transform/modify a width and/or height of the window shade 101A according to the one or more embodiments described herein. Although FIG. 1B illustrates back transforming members 112 and 113 traveling in a manner that is level horizontally across back side 103 of cloth 100 of shade 101A, it is expressly contemplated that the back transforming members 112 and 113 may travel diagonally or in any direction across back side 103 of cloth 100. Further, back transforming members 112 and 113 may be any shape, size, etc.

Although reference is made to back side 103 of window shade 101A including both back transforming members 112 and 113 that are adjacent to each other at a particular location, it is expressly contemplate that only one of back transforming members 112 and 113 may be included with window shade 101A. Further, although FIG. 1A depicts back side 103 of cloth 110 include back transforming members 112 and 113, it is expressly contemplated that the shade 101A according to the one or more embodiments as described herein may include no back transforming members 112 and 113.

In a similar manner as described above with respect to front transforming members 105 and 110, the bottom surface of the back transforming members 112 and 113 may include a portion of a securing mechanism to couple/attach the back transforming members 112 and 113 to back side 103 of cloth 100. Additionally, and as described in further detail below, the top surface of back transforming members 112 and 113 may include different portions of a securing mechanism such that a width and/or height of shade 101A may be transformed/modified.

As depicted in FIG. 1B, the back side 103 of cloth 100 of window shade 101A may further include one or more raising clips 130. In an embodiment, a raising clip 130 may include an opening (e.g., hole) 140. In an embodiment, the raising clips 130 may be secured to the front of the one or more back transforming members 112 and 113 as depicted in FIG. 1B utilizing any type of a different variety of securing mechanisms, as described above.

In an implementation, one or more pull strings 125, of a raising mechanism (not shown) may travel from a location near the head rail 115 through each of the openings 140 of the one or more raising clips 130. For example, and as depicted in FIG. 1B, there are two pull strings 125, and each pull string 125 travels from a location near the head rail 115 through the openings 140 of a series of raising clips 130 that are at different vertical positions but at similar horizontal positions on the back side 103 of the cloth 100. In an implementation, the pull string 125 may have a bottom end that is furthest away from the raising mechanism that, for example, is within or adjacent the head rail 115. The bottom end of the pull string 125 may include a knot 170 or may simply be larger in size when compared to the opening 140 of a raising clip 130 that is a lowest positioned raising clip 130 on the cloth 100.

Although reference is made to knot 170, it is expressly contemplated that any of a variety of different attachments may be secured to the bottom end of the pull string. Although FIG. 1B illustrates the raising clips 130 being at particular locations on cloth 100, it is expressly contemplated that the raising clips 130 may be at any locations on cloth 100 to, for example, accommodate different window shade configurations with differing locations of headrail 115 and pull strings 125, for example. In alternative embodiments, a pull string 125 may not be required and the window shade 101A, according to the one or more embodiments described herein, may operate as a roller shade where the cloth 100 rolls onto a roller that is within the headrail 115.

In an embodiment, and when a pull cord 120 is pulled to raise the window shade 101A, the pull strings 125 can retract/shorten and roll up on a rod or other component (not shown) of the raising system (not shown), and the bottom end of the pull strings 125, that is larger than the opening 140 of the lowest positioned raising clips 130, causes the cloth 100 of the shade 101A to be raised to different desired height, for example. Although the window shade 101A of FIGS. 1A and 1B include a pull cord 120 style raising mechanism, it is expressly contemplated that the window shade 101A according to the one or more embodiments described herein may be utilized with any of a variety of different types of raising mechanisms (e.g., motor, pull/push, roller etc.).

As previously mentioned, the window shade 101A according to the one or more embodiments described herein may be transformed/modified in terms of width such that the window shade 101A can fit different window openings having different widths.

Specifically, and as depicted in FIG. 1B, the back transforming members 112 and 113 appear as horizontal strips with a front surface that is exposed and facing a window when the window shade 101A is within a window opening (the back surface of the back transforming members 112 and 113 are in contact and attached to the cloth 100). A left and right end portion of each of the back transforming members 112 and 113 may include a first portion of a securing mechanism while the other interior portions of the back transforming members 112 and 113 may include a second portion of the securing mechanism.

For example, let it be assumed that the back transforming members 112 and 113 are each 36 inches horizontally. In this example, 3 inches from the left and 3 inches from the right of the back transforming members may include a plurality of hooks. Additionally, the middle 30 inches may include a plurality of loops. As explained above, the back surface of the back transforming members 112 and 113 are attached to the cloth 100. Therefore, if a user were to fold/bend the cloth 100 (as depicted in FIG. 1B) 6 inches on each side, the attached back transforming members 112 and 113 would also bend/fold such that the plurality of hooks on the two ends of the back transforming members 112 and 113 can mate with the plurality of loops in the interior portion of the back transforming members 112 and 113 such that the shade 101A is transformed to a 24 inch wide shade and that includes folds 131. The mating allows for the shade 101A to securely stay at this user desired width. As such, the user has the capability to modify the shade 101A to any width through the mating of the portions of the securing mechanisms that are located at the ends and interior of the back transforming members 112 and 113 to create folds 131.

Although reference is made to the back transforming members 112 and 113 including different portions of a securing mechanism, it is expressly contemplated that the entirety of the back transforming members may include a single type of securing mechanism that is self-engaging. For example, the top surface of the back transforming members 112 and 113 in their entirety may be mixed with a plurality of hooks and a plurality of loops such that any portion of the top surface can mate with a different portion of the top surface.

Additionally, the height of the shade 101A may be modified by way of mating of respective portions of securing mechanisms that are at different heights. For example, a user may fold/roll up a shade such that a back transforming member 112 or 113 at a lower position can mate with a back transforming member 112 or 113 at a higher position to reduce the height of the shade. For example, FIG. 1C depicts a shade modified in height utilizing back transforming members mating according to the one or more embodiments as described herein. As depicted in FIG. 1C, a bottom most back transforming member 112 is raised to mate with a back transforming member 113 located at a higher position on cloth 100 such that a height of the shade 101A is modified. Specifically, the height of the shade 101A is decreased based on the mating of the back transforming members.

Therefore, the shade 101A according to the one or more embodiments described herein can be modified in terms of height and width utilizing the back transforming members 112 and 113 that may be at any locations on cloth 100, as described herein. FIGS. 1A and 1B are, respectively, front and back views of a flat front Roman shade that can have (1) a modified width based on folded over portions 130 and (2) a modified height based on back transforming members 112 and 113 as described herein.

FIG. 1D illustrates a close-up view of front transforming members 105 and 110 (e.g., adjacent front transforming members) that can be coupled together to modify a height of shade 101A and/or transform. More specifically, FIG. 1D shows adjacent front transforming members 105 and 110, on the front side 102 of cloth 100, that are not coupled together. Conversely, FIG. 1E shows adjacent front transforming members 105 and 110 that are couple/mated to modify a height of shade 101A and/or transform/change a shade from a first type to a second type as will be described in further detail below.

Specifically, and as depicted in FIGS. 1D and 1E, the front transforming members 105 and 110 may be utilized to modify a height of the shade 101A and/or a style/type of the shade 101A. As previously explained, each of the front transforming members 105 and 110 have a bottom surface that is in contact with the cloth 100 and a top surface that is not contact with the cloth 100. The top surface of adjacent front transforming members 105 and 110 may have respective portions of a securing mechanism. For example, a particular front transforming member 105 may have a plurality of loops while an adjacent transforming member 110 may have a plurality of hooks. As such, a user can “pinch” the cloth 100 from the back side such that the top surface of adjacent front transforming members 105 and 110 contact each other, as depicted in FIG. 1E. Accordingly, respective portions of the securing mechanisms mate to keep the shade 101A in this configuration as depicted in FIG. 1E that illustrates a front and back of the shade 101A, respectively.

For example, let it be assumed that each of two adjacent front transforming members 105 and 11 have a height of 4 inches. Therefore, and based on the pinching of the cloth on the back side such that the adjacent front transforming members contact and attach, the shade is reduced in height by 8 inches. Therefore, if the shade 101A includes 4 sets of adjacent front transforming members (e.g., a total of 8 front transforming members), the user can alter the shade to have a variety of different height and reduce the shade by a total 32 inches utilizing the front transforming members 105 and 110A. That is, and based on the pinching, adjacent transforming members may transform from the configuration as depicted in FIG. 1D to the configuration as depicted in FIG. 1E.

Additionally, and by pinching the cloth 100 as described above such that adjacent front transforming members 105 and 110 contact and attach/couple as depicted in FIG. 1E, the shade 101A can transform from being a flat front to be a shade with one or more pleats/folds (e.g., plain fold Roman Shade) on front side of alternative shade 101A.

Specifically, a pleat is formed at each location where two adjacent front transforming members are attached based on the pinching of the cloth as described herein. Stated another way, the cloth 100 can have a break/fold/pleat at each location where two adjacent front transforming members are caused to mate/couple. Therefore, and at each location where adjacent front transforming members mate, the shade 101 transforms at that location from the configuration as depicted in FIG. 1D to the configuration as depicted in FIG. 1E.

Although reference is made to adjacent front transforming members 105 and 110 including different portions of a securing mechanism, it is expressly contemplated that the cloth 100 may include a single type of securing mechanism that is self-engaging. For example, the top surface of the a front transforming member 105 in its entirety may be mixed with a plurality of hooks and a plurality of loops such that the front transforming member 105 can be pinched in half (i.e., folded) as described above such that the top surface can mate with a different portion of the top surface. For example, if a front transforming member 105 is 8 inches in height, a user may pinch the cloth 100 from behind such that the front transforming member self-engages to reduce the height of the shade 101A by 8 inches and creates a pleat.

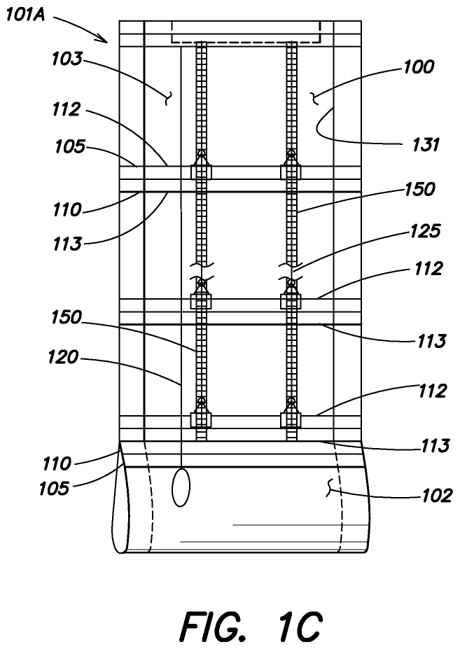

FIGS. 2A and 2B illustrate a different shade 101B may be transformed to a hobbled or teardrop Roman shade according to the one or more embodiments as described herein. To transform the shade 101B, one or more ribbons 150 (e.g., two ribbons in FIG. 2B) on the back of the shade 101B. Specifically, and as depicted in FIG. 2B, two ribbons 150 traverse a height of the shade 101B on the back of the shade 101B. The raising clips 130, which are also depicted in FIG. 1B, can be coupled to the back side of the cloth 100. The openings 140 of the raising clips 130 may engage with the ribbons 150 at different locations on the ribbons 150 to transform the shade 101B to a hobbled or teardrop Roman shade as depicted in the front view of FIG. 2A. For example, an opening 140 of a raising clip 130 may have a resting location that corresponds to a point on a ribbon 150 when the ribbon is hanging vertically due to gravity. If, for example, a user lifts the raising clip 130 to a higher location in relation to the resting location and the opening 140 is coupled to a higher point (than the corresponding point) on the ribbon 150, a hobble or teardrop Roman portion may be created as depicted in FIGS. 2A and 2B. FIG. 1F is a close-up view of a raising clip 130 with opening that is engaged with ribbon 150 according to the one or more embodiments as described herein.

Thus, the shade 101B of FIGS. 2A and 2B can be transformed in (1) width utilizing the back transforming members 112 and 113, (2) in height utilizing the front transforming members 105 and 110 (e.g., pinching), and (3) to a hobbled Roman shade utilizing the ribbons 150 and raising clips 130 as described above. Although the above description describes engaging the opening 140 with the ribbons 150, it is expressly contemplated that the raising clips 130 may include a securing mechanism instead of openings 140, and the securing mechanism of raising clips 130 may engage with ribbons 150 that includes a securing mechanism.

In a further embodiment, and as depicted in FIGS. 2A and 2B, one or more strengthening rods 160 may be attached to the back of the shade 101B to provide rigidity and structure to the hobbled shade. The strengthening rods 160 may be secured to the back of the shade 101B at any of a variety of different locations and utilizing any of a variety of different securing mechanisms.

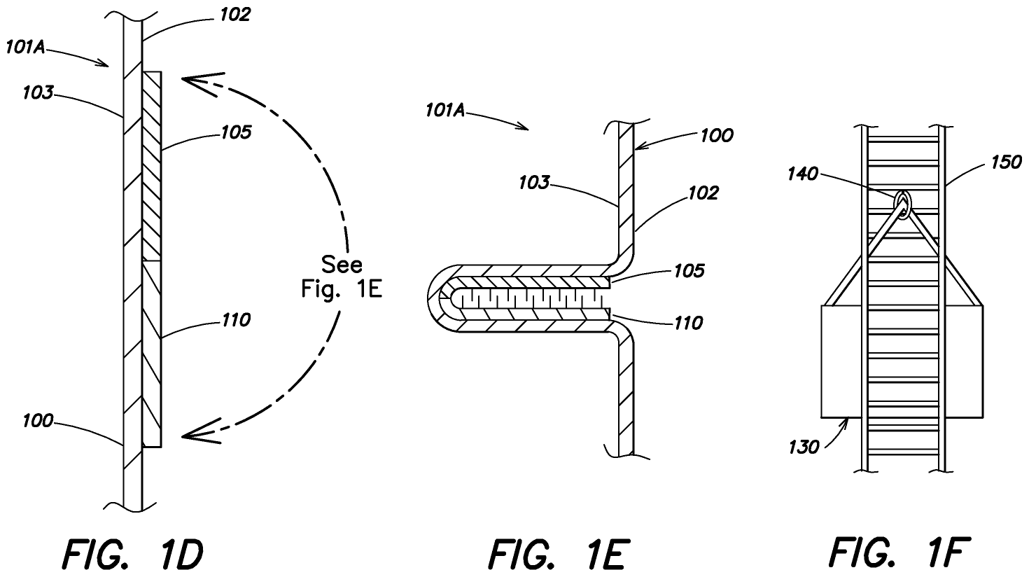

In addition or alternatively to modifying the width of the shade 101B as described above, the width of the shade may also be modified as depicted in FIGS. 3A and 3B.

FIGS. 3A and 3B illustrate an alternative shade 101C that may be transformed width and/or height according to the one or more embodiments as described herein; Specifically, one or more portions on the back side 103 of the shade 101C may include a securing mechanism, e.g., self-engaging or two different mating portions, such that the cloth 100 may be pinched to create one or more exterior folds 4002, as depicted in FIG. 3A, that run vertically along the cloth 100. In an embodiment, the securing mechanism may be of any type as described above. Alternatively, the securing mechanism may be pleat craft tape.

In an implementation, a user may desire to have the one or more exterior folds 4002 at one or more particular locations along the width of the shade 101C such that the shade 101C has a particular appearance in terms of folds (e.g., location and/or number of folds). To that end, the user may pinch the front side 102 of the cloth 100 such that the one or more securing mechanisms on the back side 103 of the cloth 100 engages to create the folds and thus modify, e.g., decrease, the width of the shade 101C as depicted in FIGS. 3A and 3B. If the user wants to widen the shade 101C, for example, the user may remove one or more exterior folds be disengaging one or more securing mechanisms on the back side 103 of the cloth 100. In an embodiment, the securing mechanisms on the back side 103 of the cloth 100 may be at any of a variety of different locations on the back side 103 of the cloth 100.

Thus, the shade 101C according to the one or more embodiments described herein may be modified in width utilizing the exterior folds 4002 and/or the back transforming members 112 and 113 as described above. In addition or alternatively, the height of the shade 101C may be modified utilizing the back transforming members 112 and 113 and/or front transforming members 105 and 110 as described above.

In addition or alternatively, the one or more securing mechanisms on the back side of the shade 101C may also be utilized to create exterior folds 4003, as depicted in FIG. 3B, that run horizontally across the cloth 100 to modify the height of the shade 101C. In a similar manner as described above, a user may create one or more exterior folds 4003 at one or more particular locations by pinching the front side 102 on the cloth 100 such that the one or more securing mechanisms on the back side 103 of the cloth 100 engage. In addition or alternatively, the shade 101C of FIGS. 3A and 3B may also be modified in width utilizing the back transforming members 112 and 113 as described above. In addition or alternatively, the height of the shade 101 of FIGS. 3A and 3B may also be modified in height utilizing the front transforming members 105 and 110 and/or the back transforming members 112 and 113 as described above.

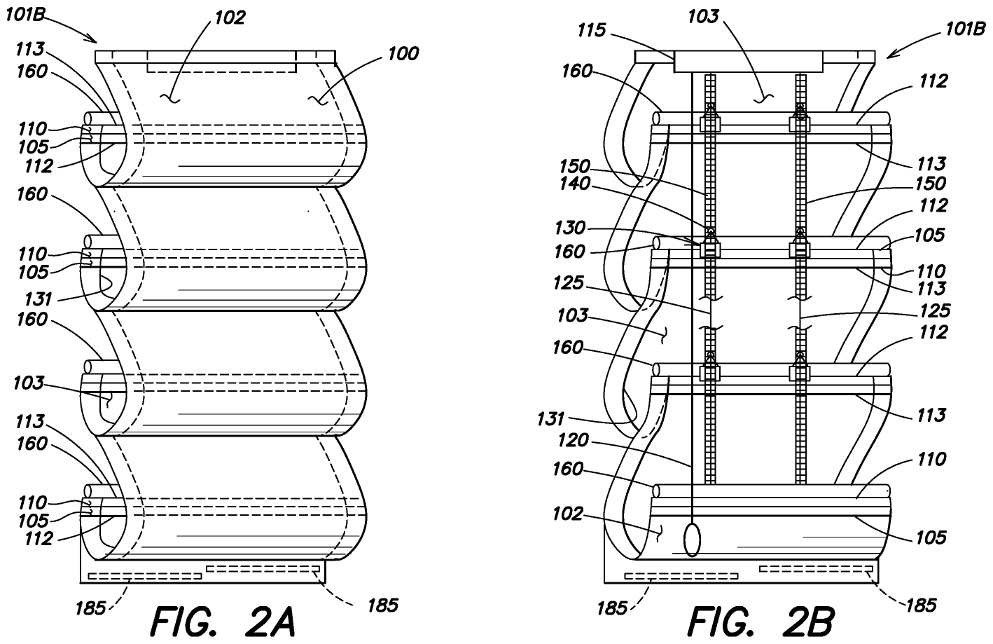

In an implementation, the shade according to the one or more embodiments described herein may be utilized in different environments and/or for different purposes. For example, the shade (e.g., 101A-101D) according to the one or more embodiments described herein may be utilized as an awning as depicted in FIG. 4. Specifically, the awning 101E may include 4 legs 500 (e.g., 3 are shown in FIG. 4) with first ends that make contact with a ground surface. In an implantation, the legs 500 may be made of any type of material (e.g., metal, wood, etc.) The other ends of the legs 500 may contact ends of ribbons 150 which, in FIG. 4, travel horizontally and contact and are secured to the back side 103 of the shade as described above. In an embodiment, the ribbons 150 of FIG. 4 may be made of any type of material (e.g., metal, wood, etc.) The awning of FIG. 4 may be modified in width, height, length and transformed to a different type of awning (e.g., without pleats/folds or with pleats/folds), in a similar manner as described above.

Additionally, the awning of FIG. 4 may be opened and closed utilizing the pull cord, in a similar manner as described above. Further, It is expressly contemplated that the shade according to the one or more embodiments as described herein may be utilized for any of a variety of different purposes.

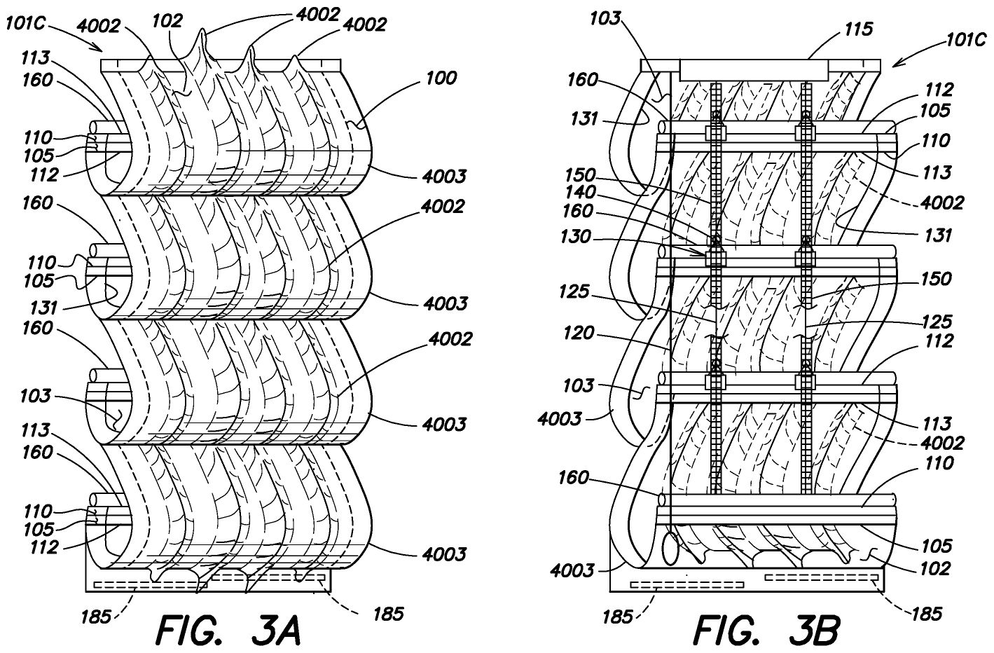

For example, FIGS. 5A and 5B illustrate a shade 101D that may utilize strengthening rods 160 that may be utilized to change a height of a shade and/or a type of shade according to the one or more embodiments as described herein. Specifically, and as depicted in FIGS. 5A and 5B, each of a plurality of strengthening rods 160 may be inserted into adjacent openings 135 of adjacent raising clips 130. In addition, and as depicted in FIG. 5B, two or more strengthening rods 160 may be coupled to each other to change a height of shade 101D and/or the type of the shade. As depicted in FIG. 5A, strips 185 may be inserted into one or more openings of cloth 100 and/or between layers of material that cloth 100 is comprised of. In an embodiment, strips 185 may provide structure or rigidity at a location where the strips 185 are located on shade 101. In an embodiment, the strips 185 may include a single strip or multiple strips and may be any of a variety of different materials. For example, such materials may include, but are not limited to, fabric, metal, plastic, bamboo, etc.

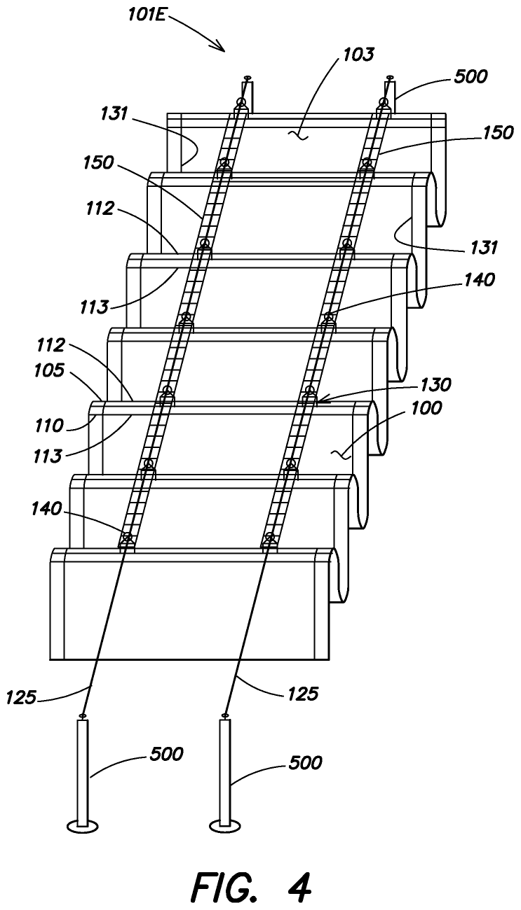

FIG. 6 depicts a shade 101F with a shade pull retracting/releasing portion 610 and strengthening rods 160 according to the one or more embodiments as described herein. Shade 101F includes strengthening rods 160. Each of the strengthening rods 160 may be positioned within the openings of clips 625 as depicted in FIG. 6. In an embodiment, each of the clips 625 may be attached to back side 103 of cloth 100 utilizing any of a variety of different securing mechanisms as described herein. Pull cord 605 may be manually manipulated, e.g., pulled by a user, to raise and lower shade 101F. For example, and based on pulling on the pull cord 605, the shade pull retracting/releasing portion 610 may roll up into head rail unit 115. In an embodiment, head rail unit 115 may include a circular structure (not shown) that the shade pull retracting/releasing portion 610 may wrap around based on the pulling of pull cord 605. Based on the pulling of pull cord 605, the shade pull retracting/releasing portion 610 may wrap around the circular structure (not shown) such that the pull bar 620 rises and then engage with the lowest positioned set of clips that house the lowest positioned strengthening rod 160. As the pull bar 620 continues to rise, additional combination of clips 625 and strengthen rod 160 (from bottom to top) are engaged to raise the shade 101F. Once the shade 101F reaches a completely open position, e.g., all of the strengthening rods 160 are engaged such that cloth 100 rises, the pull cord 605 may be additionally pulled to lower shade 101F.

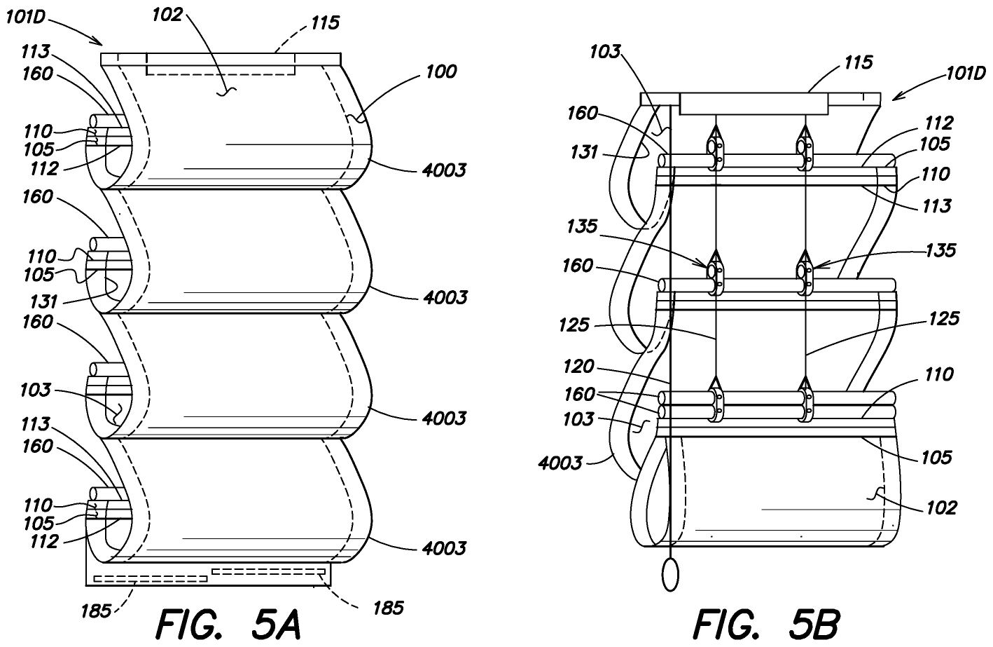

FIG. 7 depicts a shade 101G that is similar to FIG. 6 but shade 101G does not include strengthening rods 160 according to the one or more embodiments as described herein. In the embodiment, and according to FIG. 7, the pull bar 620 may with just the clips 625 such that the shade 101G can be raised in a similar manner as described above with relation to FIG. 6. Specifically, the pull bar 620 engages with the lowest positioned clips 625 and subsequently engages with each set of clips 615 that are at a higher position as the pull cloth 610 retracts such that the shade 101G, i.e., cloth 100 of shade 101G, raises. Although FIG. 7 depicts clips 625 have a particular configuration, it expressly contemplated that clips 625 may be any style, configuration, material, wherein clips 625 are coupled to cloth 100 such that pull bar can engage with clips 625 to, for example, raise the shade.

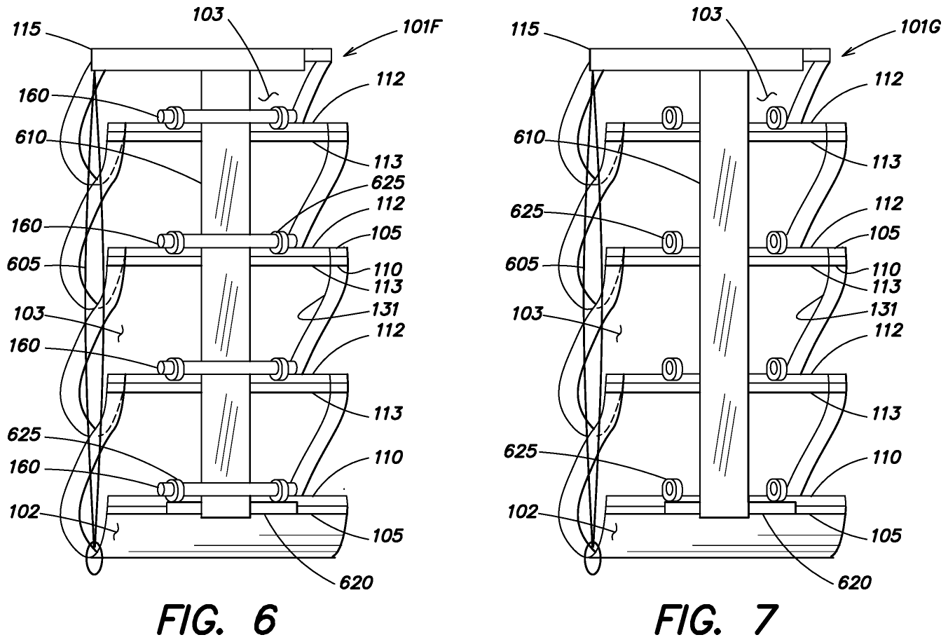

FIG. 8 depicts a shade 101H that is similar to FIG. 7 but with clips 625 that are coupled to each other using a securing mechanism 633 that, as depicted in FIG. 6, is a loop according to the one or more embodiments as described herein. In an embodiment, the height of the shade 101H may be modified to fit different window size opening, for example, by attaching or coupling adjacent clips together using securing mechanism 633. Although FIG. 8 depicts securing mechanism 633 being a loop, it is expressly contemplated securing mechanism 633 may be any of a variety of different securing mechanisms as described herein.

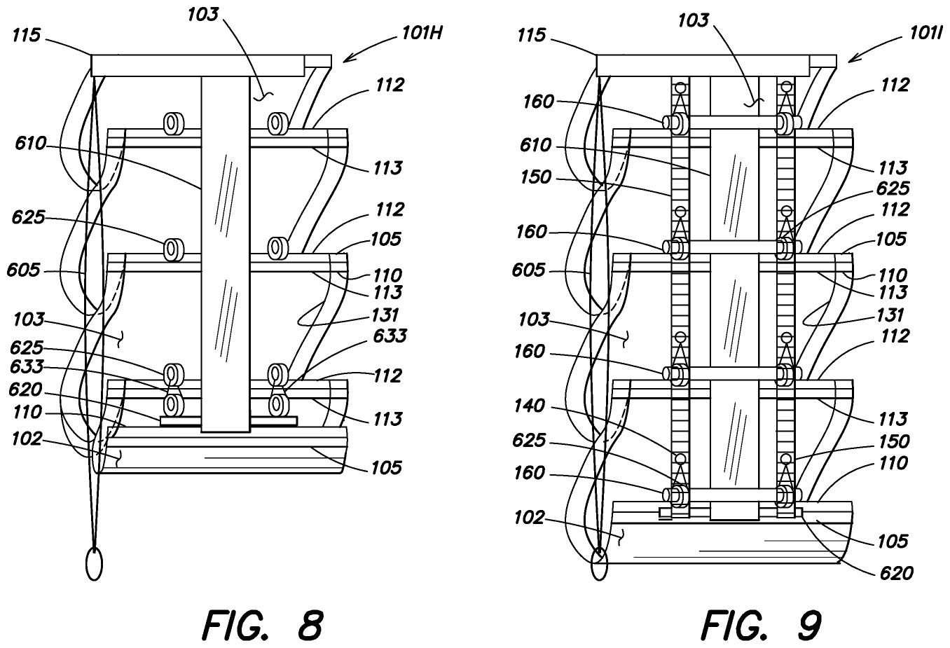

FIG. 9 depicts a shade 101I with shade pull retracting/releasing portion 610, ribbons 150, and strengthening rods 160 according to the one or more embodiments as described herein. Shade 101I may operate in a similar manner to shade 101F of FIG. 6, but shade 101I includes ribbons 150 and openings 140 that are coupled to ribbons 150 as described herein.

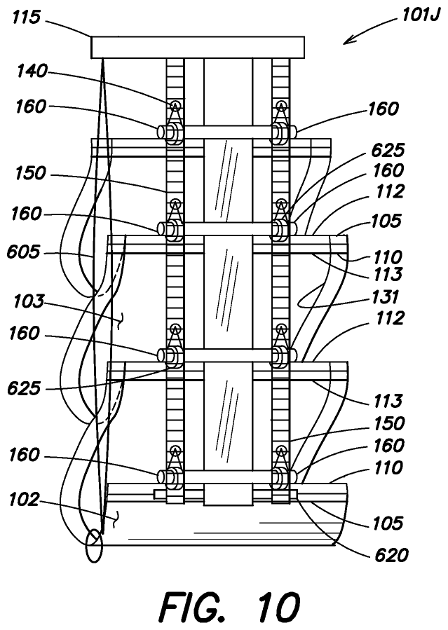

FIG. 10 depicts a top-down shade that is similar to the shade of FIG. 9 according to the one or more embodiments as described herein. In an embodiment, the openings 140 of the top most clip 625 may be disengaged from ribbon 150 and positioned at a lower point on ribbon 150 such that a space is created between the top strengthening rod 160 and head rail 115 as depicted in FIG. 10. As a result, light may enter the created space and shade 101J may operate as a top-down shade.

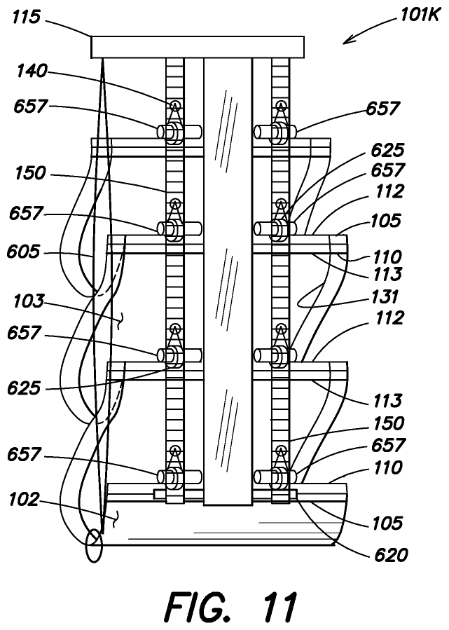

FIG. 11 is a top-down shade 101K similar to the shade of FIG. 10, however, shade 101K includes a plurality (e.g., two) of strengthening rods 657 at each level (e.g., height location) of shade 101J.

Although FIGS. 10 and 11 include strengthening rods 160 and clips 625, it is expressly contemplated that shades 101J and 101K may include strips 185 instead of strengthening rods 160 and clips 625. For example, strips 185 may be positioned within an opening of cloth 100, between layers of cloth 100, and or may be coupled to the exterior of the back side 103 of cloth 100. In an embodiment, the strips 185 may protrude a certain distance from back side 103 of cloth 101 when coupled to the exterior of the back side 103 of cloth. As such, and in this embodiment, the shade pull retracting/releasing portion may be positioned between the exterior of the back side 103 of cloth 101 and the strips 185 such that the strips 185 act as a guide for shade pull retracting/releasing portion as the shades 101J and 101K are raised and lowered. In an embodiment, shades 101J and 101K may or may not include ribbons 150. When ribbons are included with shades 101J and 101K, the strips 185 may, in an embodiment, attach/couple to ribbons in any of a variety of different ways as described herein.

It is expressly contemplated that the different features described with respect to particular figures may apply to each of the different embodiments described herein. For example, although the one or more strengthening rods 160 are included in particular FIGS., it is expressly contemplated that the other shades of other FIGS. may also include and utilize one or more strengthening rods 160. Therefore, it should expressly understood that each feature described may be utilized with any other feature described according to the one or more embodiments as described herein.

The foregoing description described certain example embodiments. It will be apparent, however, that other variations and modifications may be made to the described embodiments, with the attainment of some or all of their advantages. Accordingly, the foregoing description is to be taken only by way of example, and not to otherwise limit the scope of the disclosure. It is the object of the appended claims to cover all such variations and modifications as come within the true spirit and scope of the disclosure.

What is claimed is:

1. A shade, comprising:
a shade pull portion coupled to at least one or more shade coverings that cover a window covering, the shade pull portion retracting and lowering to raise and lower the shade;
one or more fold portions that are configured to be modified to change the shade to one or more different widths; and
each of the one or more shade coverings configured to couple to the shade at different heights of the shade to modify the shade in height and/or transform the shade from a first type of shade to a second type of shade.

2. The shade of claim 1, further comprising:
one or more transforming members coupled to a back side of each of the one or more shade coverings,
wherein excess material of each of the one or more shade coverings, that extends past the width of the one or more transforming members, is folded over to create the one or more fold portions.

3. The shade of claim 1, wherein each of the one or more shade coverings are one or more of plastic, cloth, wood, bamboo, or paper.

4. The shade of claim 1, further comprising:
a head rail;
one or more ribbons, each ribbon attached to at least the head rail; and
one or more securing mechanisms that couple the ribbon to each of the one or more shade coverings at one or more first positions.

5. The shade of claim 4, wherein the one or more securing mechanisms includes one or more of hooks and loops, magnets, buttons, zippers, snaps, clips, belt loops, or glue.

6. The shade of claim 4, wherein the shade is the first type when the ribbon is coupled to each of the one or more shade coverings at the one or more first positions.

7. The shade of claim 6, wherein the one or more securing mechanisms couple the ribbon to each of the one or more shade coverings at one or more second positions to modify the height of the shade, wherein the one or more first positions are different than the one or more second positions.

8. The shade of claim 6, wherein the one or more securing mechanisms couple the ribbon to each of the one or more shade coverings at one or more second positions to transform the shade from the first type of shade to the second type of shade.

9. The shade of claim 8, wherein the first type of shade is a flat front shade and wherein the second type of shade is a hobbled shade or a mixture of a flat shade and hobbled shade.

10. The shade of claim 1, further comprising:
one or more strips coupled to a back side of the shade and the shade pull portion,
wherein when the shade raises, the shade pull portion, coupled to each of the one or more strips, causes the one or more shade covering to rise through coupling of the shade pull portion and the one or more strips.

11. A shade, comprising:
a shade pull portion coupled to at least one or more shade coverings that cover a window covering, the shade pull portion retracting and lowering to raise and lower the shade;
one or more fold portions that are configured to be modified to change the shade to one or more different widths; and
each of the one or more shade coverings configured to couple to the shade at different heights of the shade to modify the shade in height and/or transform the shade from a first type of shade to a second type of shade.

12. The shade of claim 11, further comprising:
one or more transforming members coupled to a back side of each of the one or more shade coverings,
wherein excess material of each of the one or more shade coverings, that extends past the width of the one or more transforming members, is folded over to create the one or more fold portions.

13. The shade of claim 11, wherein each of the one or more shade coverings are one or more of plastic, cloth, wood, bamboo, or paper.

14. The shade of claim 11, further comprising:
a head rail;
one or more ribbons, each ribbon attached to at least the head rail; and
one or more securing mechanisms that couple the ribbon to each of the one or more shade coverings at one or more first positions.

15. The shade of claim 14, wherein the one or more securing mechanisms includes one or more of hooks and loops, magnets, buttons, zippers, snaps, clips, belt loops, or glue

16. The shade of claim 14, wherein the shade is the first type when the ribbon is coupled to each of the one or more shade coverings at the one or more first positions.

17. The shade of claim 16, wherein the one or more securing mechanisms couple the ribbon to each of the one or more shade coverings at one or more second positions to modify the height of the shade, wherein the one or more first positions are different than the one or more second positions.

18. The shade of claim 16, wherein the one or more securing mechanisms couple the ribbon to each of the one or more shade coverings at one or more second positions to transform the shade from the first type of shade to the second type of shade.

19. The shade of claim 18, wherein the first type of shade is a flat front shade and wherein the second type of shade is a hobbled shade or a mixture of a flat shade and hobbled shade.

20. A shade, comprising:
one or more clips that are coupled to at least one or more shade coverings that cover a window covering, the one or more clips configured to be manipulated to raise and lower the shade;
one or more fold portions that are configured to be modified to change the shade to one or more different widths; and
each of the one or more shade coverings configured to couple to the shade at different heights of the shade to modify the shade in height and/or transform the shade from a first type of shade to a second type of shade.
